(19) United States
(12) Patent Application Publication
(10) Pub. No.: US 2025/0276435 A1
(43) Pub. Date: Sep. 4, 2025

(54) MOBILE WORK BOX

(71) Applicant: Matthew Uzl, Tallmadge, OH (US)

(72) Inventor: Matthew Uzl, Tallmadge, OH (US)

(21) Appl. No.: 19/052,238

(22) Filed: Feb. 12, 2025

Related U.S. Application Data
(60) Provisional application No. 63/560,659, filed on Mar. 2, 2024.

(51) Int. Cl. B25H 3/02

(52) U.S. Cl. CPC B25H 3/028; B25H 3/026

(57) ABSTRACT

A mobile work box includes: a box body, a lid, and a plurality of casters. The box body includes a plurality of storage portions and has an opening. The plurality of storage portions are configured to store work tools therein, the plurality of storage portions are capable of being accessed through the opening. The lid is detachably connected to the box body. When the lid is connected to the box body, the lid covers the opening; and when the lid is detached off from the box body, the opening is exposed, and the plurality of storage portions are exposed through the opening. The plurality of casters are disposed at a bottom of the box body opposite to the opening. The plurality of casters are movable.

### TECHNICAL FIELD

Embodiments of the present disclosure relate to the technical field of tool storage devices, and more specifically, to a mobile work box.

### BACKGROUND

Tool storage devices are commonly used to store and organize tools and accessories, especially when the tools and the accessories need to be transported between and around worksites. Therefore, a mobile work box, which is portable, durable, and is easily accessible, is needed.

### SUMMARY

The present disclosure provides a mobile work box, including: a box body, a lid detachably connected to the box body, and a plurality of casters. The box body includes a plurality of storage portions and having an opening. The plurality of storage portions are configured to store work tools therein, the plurality of storage portions are capable of being accessed through the opening. When the lid is connected to the box body, the lid covers the opening; and when the lid is detached off from the box body, the opening is exposed, and the plurality of storage portions are exposed through the opening. The plurality of casters are disposed at a bottom of the box body opposite to the opening. The plurality of casters are movable.

According to the present disclosure, the box body includes the plurality of storage portions. In this way, when the box body receives a large number of tools, the large number of tools can be well organized, for example, based on sizes of the tools or based on functions of the tools. The lid is detachably connected to the box body, such that the opening of the box body can be fully exposed, and the user may easily access any desired one of the plurality of storage portions to store or take out the tools. The plurality of movable casters enable the box body to be highly portable. In this way, the mobile work box provides a large storage space and is well organized and highly portable.

### BRIEF DESCRIPTION OF THE DRAWINGS

In order to more clearly illustrate technical solutions in embodiments of the present disclosure, accompanying drawings used in the embodiments will be briefly introduced below. Obviously, the accompanying drawings in the following description show only some of the embodiments of the present disclosure, and any ordinary skilled person in the art may obtain other accompanying drawings based on these drawings without creative work.

FIG. 1 is a structural schematic view of a mobile work box where a lid covers a box body, according to an embodiment of the present disclosure.

FIG. 2 is a structural schematic view of the mobile work box where the lid is detached off from the box body, according to an embodiment of the present disclosure.

FIG. 3 is an exploded view of the mobile work box according to an embodiment of the present disclosure.

FIG. 4 is a cross-sectional view of the mobile work box shown in FIG. 2, taken along a line A-A.

FIG. 5 is a cross-sectional view of the mobile work box shown in FIG. 3, taken along a line B-B.

FIG. 6 is a cross-sectional view of the mobile work box shown in FIG. 3, taken along a line C-C.

FIG. 7 is a structural schematic view of the mobile work box, being viewed from another viewing angle, according to an embodiment of the present disclosure.

FIG. 8 is a structural schematic view of a portion of the mobile work box, having the lid omitted, according to an embodiment of the present disclosure.

### DETAILED DESCRIPTIONS

It should be noted that terms “first”, “second” and “third” in the present disclosure are used to distinguish different objects from each other and shall not be used to describe a particular order. Furthermore, the terms “include” and “have”, and any variations thereof, are intended to cover non-exclusive inclusion. For example, a process, a method, a system, a product, or an apparatus that includes a series of steps or modules is not limited to the listed steps or modules, but further includes steps or modules that are not listed or includes steps or modules that are inherently included in the process, the method, the system, the product, or the apparatus.

Reference to “embodiments” implies that particular features, structures, or characteristics described in an embodiment may be included in at least one embodiment of the present disclosure. Presence of the term at various sections in the specification does not necessarily refer to one same embodiment or to separate or alternative embodiments that are mutually exclusive to other embodiments. Any ordinary skilled person in the art shall understand, both explicitly and implicitly, that the embodiments described herein may be combined with other embodiments.

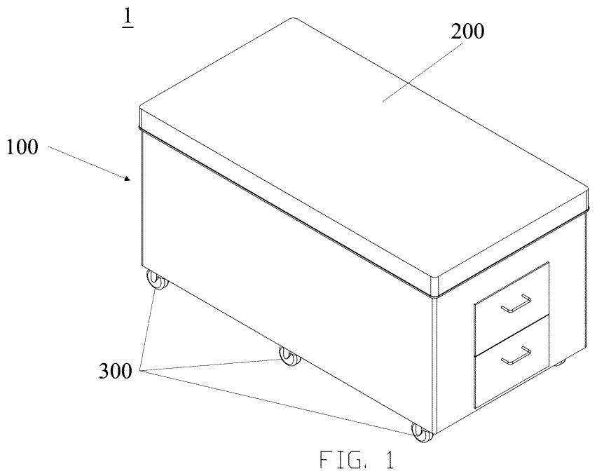

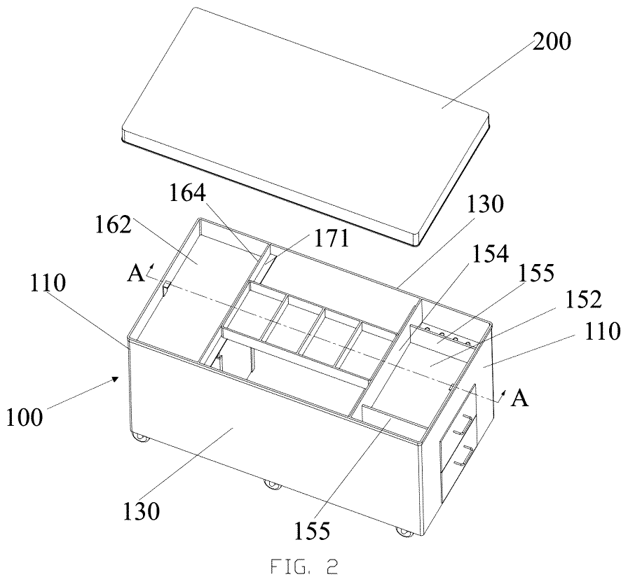

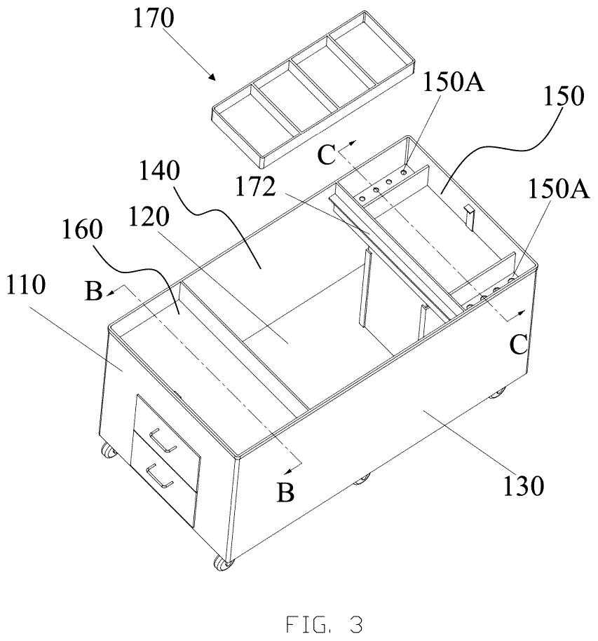

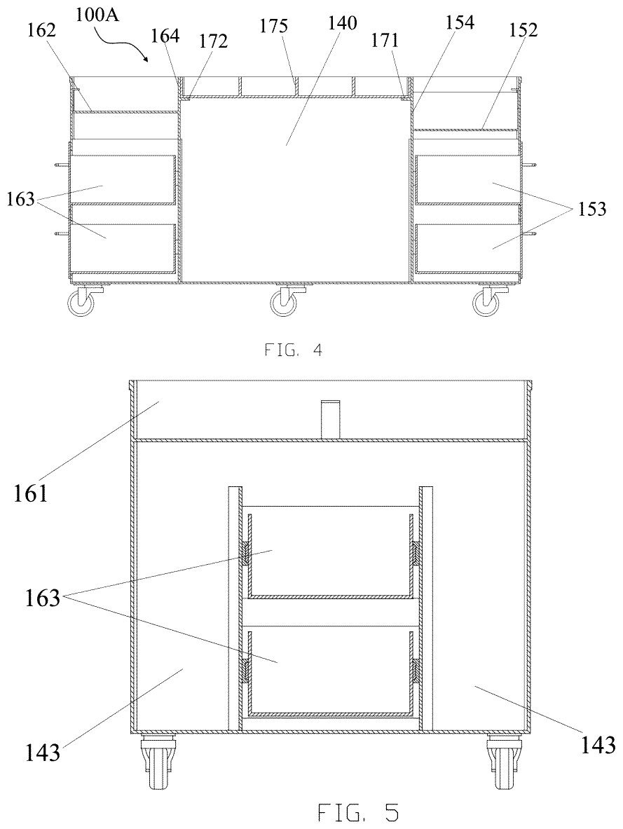

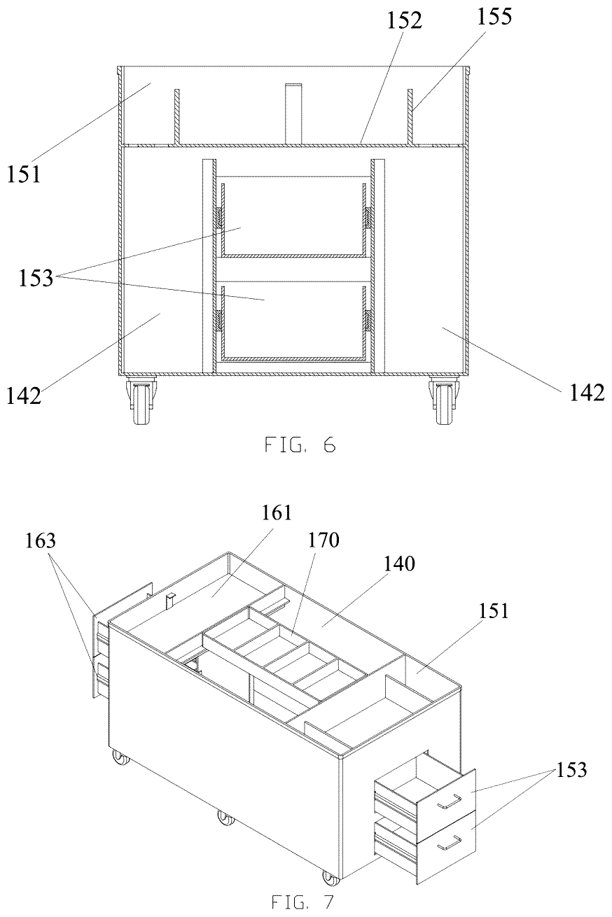

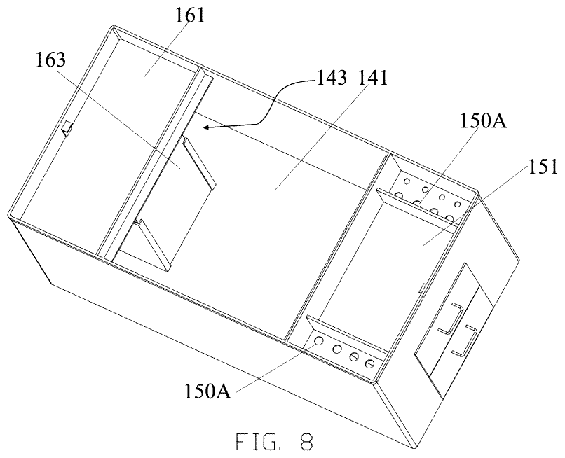

As shown in FIGS. 1 to 8, the present disclosure provides a mobile work box 1, including: a box body 100, a lid 200, and a plurality of casters 300. The box body 100 includes a plurality of storage portions and has an opening 100A. The plurality of storage portions are configured to store work tools therein, the plurality of storage portions are capable of being accessed through the opening 100A. The lid 200 is detachably connected to the box body 100. When the lid 200 is connected to the box body 100, the lid 200 covers the opening 100A; and when the lid 200 is detached off from the box body 100, the opening 100A is exposed, and the plurality of storage portions are exposed through the opening 100A. The plurality of casters 300 are disposed at a bottom of the box body 100 opposite to the opening 100A and are movable.

Specifically, the plurality of storage portions may have different storage volumes, and therefore, work tools of various sizes can be stored in one or more of the plurality of storage portions having a proper storage volume. Each of the plurality of storage portions has a respective opening, and openings of at least some of the plurality of storage portions are communicated with each other. Alternatively, the openings of the at least some of the plurality of storage portions cooperatively form the opening 100A of the entire bod body, and the lid 200 covers the opening 100A of the entire bod body formed by the openings of the at least some of the plurality of storage portions.

In the present embodiment, the lid 200 is detachably connected to the box body 100. For example, the entire lid 200 can be disconnected from the box body 100, i.e., the entire opening 100A of the box body 100 and all edges of the opening 100A of the box body 100 are uncovered by the lid 200. In this way, the opening 100A of the box body 100 is fully exposed, and the plurality of storage portions can be easily accessed by a user.

Furthermore, the plurality of casters 300 are movable, and therefore, when the mobile work box 1 needs to be moved to a certain worksite, the user may drive the plurality of casters 300 to move to carry the box body 100 to move. The plurality of casters 300 may be wheels, and therefore, even when the box body 100 is heavy, due to carrying a large number of tools, the plurality of casters 300 can still roll easily to carry the box body 100.

According to the present embodiment, the box body 100 includes the plurality of storage portions. In this way, when the box body 100 receives a large number of tools, the large number of tools can be well organized, for example, based on sizes of the tools or based on functions of the tools. The lid 200 is detachably connected to the box body 100, such that the opening 100A of the box body 100 can be fully exposed, and the user may easily access any desired one of the plurality of storage portions to store or take out the tools. The plurality of movable casters 300 enable the box body 100 to be highly portable. In this way, the mobile work box 1 provides a large storage space and is well organized and highly portable.

Specifically, the box body 100 includes two shorter side walls 110, two longer side walls 130, and a bottom wall 120. The two shorter side walls 110 and the two longer side walls 130 are connected to the bottom wall 120. The two shorter side walls 110, the two longer side walls 130, and the bottom wall 120 cooperatively form the plurality of storage portions.

For example, the two shorter side walls 110, the two longer side walls 130, and the bottom wall 120 cooperatively define an inner cavity of the box body 100, and the inner cavity may be divided to form the plurality of storage portions. In an embodiment, an overall size of the box body 100 may be 13-14 inches high (such as 13.5 inches), 47-48 inches long (such as 47.5 inches) and 19-20 inches wide (such as 19.25), and a size of the lid 200 can be properly designed to enable the lid 200 to cover the opening 100A of the box body 100.

In some embodiments, a partition plate may be arranged in the inner cavity and connected to at least some of the two shorter side walls 110, the two longer side walls 130, and the bottom wall 120 to divide the inner cavity. The partition plate may be detachably arranged in the inner cavity or may be integrally formed with the at least some of the two shorter side walls 110, the two longer side walls 130, and the bottom wall 120.

In some embodiments, a storage container, having its own container walls, may be arranged in the inner cavity. That is, the storage container may be arranged inside the box body 100 or may be taken out of the box body 100 to be used independent from the box body 100.

Specifically, the plurality of storage portions includes a bulk storage portion 140, a first side storage portion 150, and a second side storage portion 160, and at least a portion of the bulk storage portion 140 is disposed between the first side storage portion 150 and the second side storage portion 160.

For example, the first side storage portion 150, the at least the portion of the bulk storage portion 140, and the second side storage portion 160 may be successively distributed along each of the two longer side walls 130. The first side storage portion 150 is disposed near one of the two shorter side walls 110, and the second side storage portion 160 is disposed near the other one of the two shorter side walls 110.

In some embodiments, the bulk storage portion 140 has a central storage space 141 disposed between the first side storage portion 150 and the second side storage portion 160. The central storage portion extends through a depth of the entire box body 100. That is, the central storage portion of the bulk storage portion 140 extends from the bottom wall 120 to a top edge of each of the two longer side walls 130. The central storage portion of the bulk storage portion 140 has a bulk storage opening, serving as a part of the opening 100A of the entire box body 100. The user may access the central storage portion of the bulk storage portion 140 through the bulk storage opening when the lid 200 is detached.

Furthermore, the first side storage portion 150 includes a first upper storage portion 151 and a first lower storage portion 153; and the second side storage portion 160 comprises a second upper storage portion 161 and a second lower storage portion 163.

Specifically, the first upper storage portion 151 is disposed above the first lower storage portion 153. The first upper storage portion 151 has a first upper storage opening, serving as a part of the opening 100A of the entire box body 100. The user may access the first upper storage portion 151 through the first upper storage opening when the lid 200 is detached. The second upper storage portion 161 is disposed above the second lower storage portion 163. The second upper storage portion 161 has a second upper storage opening, serving as a part of the opening 100A of the entire box body 100. The user may access the second upper storage portion 161 through the second upper storage opening when the lid 200 is detached.

In some embodiments, the first lower storage portion 153 includes at least one first drawer that is slidable along a length direction of the box body 100; and the second lower storage portion 163 includes at least one second drawer that is slidable along a length direction of the box body 100.

Specifically, the at least one first drawer is slidable in a first direction to be exposed out of the box body 100; the at least one second drawer is slidable in a second direction to be exposed out of the box body 100; the second direction is opposite to the first direction. In some embodiments, a size of each of the at least one first drawer is substantially equal to a size of each of the at least one second drawer. For example, the size of each of the at least one first drawer and each of the at least one second drawer is 7-8 inches high (such as 7.5 inches), 10-11 inches long (such as 10.5 inches), and 9 inches wide.

In the present embodiment, an opening of the at least one first drawer and an opening of the at least one second drawer do not form a part of the opening of the box body 100. However, the user can access storage spaces of the at least one first drawer and the at least one second drawer by sliding the at least one first drawer and the at least one second drawer out of the box body 100.

The bulk storage portion 140 further has a first side storage space 142 and a second side storage space 143. The central storage space 141 is located between the first side storage portion 150 and the second side storage portion 160. The first side storage space 142 is defined between side walls of the at least one first drawer and the two longer side walls 130 of the box body 100. That is, a width of the at least one first drawer is less than a width of the one of the two shorter side walls 110 of the box body 100.

The box body 100 further includes a first side supporting plate 152 and a first side dividing plate 154. The first side supporting plate 152 is disposed on a top of the at least one first drawer. For example, the first side supporting plate 152 may be supported on a top wall of the at least one first drawer. Three of four edges of the first side supporting plate 152 are respectively connected to one of the two shorter side walls 110 and the two longer side walls 130 of the box body 100, and the first side dividing plate 154 is connected to a rest one of the four edges of the first side supporting plate 152. The first side dividing plate 154 is then extending from the rest one of the four edges of the first side supporting plate 152 towards the top edge of each of the two longer side walls 130. In this way, the first side supporting plate 152, the first side dividing plate 154, a portion of one of the two shorter side walls 110, and portions of the two longer side walls 130 cooperatively define the first upper storage portion 151 that is disposed above the at least one first drawer.

Furthermore, two partition walls 155 are arranged and connected between the one of the two shorter side walls 110 of the box body 100 and the first side dividing plate 154; the two partition walls 155 are extending from the first side supporting plate 152 towards the first upper storage opening. In this way, the two partition walls 155 divides the first upper storage portion 151 to form a first middle storage space and two first upper-side storage spaces respectively located at two sides of the first middle storage space.

Specifically, a portion of the first side supporting plate 152 for forming the two first upper-side storage spaces defines a plurality of through holes 150A. In this way, the two first upper-side storage spaces are communicated with the first side storage space 142 of the bulk storage portion 140 through the plurality of through holes 150A. In some embodiments, elongated tools may be received in the two first upper-side storage spaces, extending through the plurality of through holes 150A, to be further received in the first side storage space 142 of the bulk storage portion 140. That is, elongated tools, having a large length, may be stored and well organized in the box body 100.

Furthermore, the box body 100 further includes a second side supporting plate 162 and a second side dividing plate 164. The second side supporting plate 162 is disposed on a top of the at least one second drawer; three of four edges of the second side supporting plate 162 are respectively connected to the other one of the two shorter side walls 110 and the two longer side walls 130 of the box body 100. The second side dividing plate 164 is connected to a rest one of the four edges of the second side supporting plate 162; the second side dividing plate 164 is then extending from the rest one of the four edges of the second side supporting plate 162 towards the opening 100A of the box body 100. The other one of the two shorter side walls 110 and portions of the two longer side walls 130 of the box body 100, the second side supporting plate 162, and the second side dividing plate 164 cooperatively form the second upper storage portion 161.

The second side storage space 143 of the bulk storage portion 140 is defined between side walls of the at least one second drawer and the two longer side walls 130 of the box body 100.

In the present embodiment, the second upper storage portion 161 has one storage space that is not divided by any partition plate. In this way, the one storage space of the second upper storage portion 161 and various storage spaces of the first upper storage portion 151 may have different sizes. For example, the one storage space of the second upper storage portion 161 is longer than the first middle storage space of the first upper storage portion 151. Therefore, the second upper storage portion 161 and the first upper storage portion 151 are designed for storing different kinds of tools, such that tools stored in the box body 100 can be well organized. Of course, in some embodiments, tools of the same size may be separately stored in the first upper storage portion 151 and the second upper storage portion 161, as long as storage spaces are suitable for receiving the tools.

In the present embodiment, the box body 100 further includes a movable storage tray 170 that is disposed between the first upper side storage portion and the second upper side storage portion and occupies an upper portion of the bulk storage portion 140. The movable storage tray 170 is movable between the two longer side walls 130 of box body 100.

In some embodiments, the movable storage tray 170 is detachable from the box body 100, and that is, the movable storage tray 170 can be used independently from the box body 100. Therefore, the movable storage tray 170 is designed to have a size that is easily portable, for example, the movable storage tray 170 is 2 inches high, 24 inches long and 8-9 inches wide (such as 8.25 inches).

In some embodiments, the box body 100 further includes a first tray supporting strip 171 and a second tray supporting strip 172. The first tray supporting strip 171 is extending from a side of the first side dividing plate 154 away from the first upper storage space towards the second upper storage portion 161. The second tray supporting strip 172 is extending from a side of the second side dividing plate 164 away from the second upper storage space towards the first upper storage portion 151. When the movable storage tray 170 is arranged in the box body 100, two opposite sides of a bottom wall of the movable storage tray 170 are respectively supported on and movable along the first tray supporting strip 171 and the second tray supporting strip 172.

When the movable storage tray 170 is supported on the first tray supporting strip 171 and the second tray supporting strip 172, two opposite side walls of the movable storage tray 170 are respectively limited by the first side dividing plate 154 and the second side dividing plate 164. That is, the movable storage tray 170 can move only from one of the two longer side walls 130 of the box body 100 to the other one of the two longer side walls 130 of the box body 100, but cannot move from one of the two shorter side walls 110 of the box body 100 to the other one of the two shorter side walls 110. That is, the movable storage tray 170 can slide only above the bulk storage portion 140 but cannot slide over the first upper storage portion 151 or the second upper storage portion 161.

Specifically, the movable storage tray 170 includes a plurality of removable dividers 175. When the plurality of removable dividers 175 are removed out of the movable storage tray 170, the movable storage tray 170 has one tray storage space; and when the plurality of removable dividers 175 are arranged in the movable storage tray 170, the tray storage space is divided into a plurality of tray storage sub-spaces. Therefore, a storage space of the movable storage tray 170 can be adjusted according to demands. For example, two, three, or four removable dividers 175 may be arranged in the movable storage tray 170.

In some embodiments, the box body 100 is made of rigid materials; and the rigid materials include metal, such as stainless steel.

In some embodiments, the number of the plurality of casters 300 is six. In some embodiments, the number of the plurality of casters 300 and distribution of the plurality of casters 300 may be adjusted according to demands. For example, the number of the plurality of casters 300 and the distribution of the plurality of casters 300 may be determined based on a gravitational center of the mobile work box 1.

In some embodiments, the number of the at least one first drawer is two or more; and the number of the at least one second drawer is two or more.

In some embodiments, the first upper storage portion 151 and the second upper storage portion 161 have a same length and a same width; but a depth of the first upper storage portion 151 is greater than a depth of the second upper storage portion 161. For example, each of the first upper storage portion 151 and the second upper storage portion 161 is 11-12 inches long (such as 11.5 inches) and 19-20 inches wide (such as 19.25 inches). The depth of the first upper storage portion 151 may be 5 inches deep, and the depth of the second upper storage portion 161 may be 3 inches deep.

According to the present embodiment, the box body 100 includes the plurality of storage portions. In this way, when the box body 100 receives a large number of tools, the large number of tools can be well organized, for example, based on sizes of the tools or based on functions of the tools. The lid 200 is detachably connected to the box body 100, such that the opening 100A of the box body 100 can be fully exposed, and the user may easily access any desired one of the plurality of storage portions to store or take out the tools. The plurality of movable casters 300 enable the box body 100 to be highly portable. In this way, the mobile work box 1 provides a large storage space and is well organized and highly portable.

The above description shows only optional embodiments of the present disclosure and is not intended to limit the present disclosure, and any modifications, equivalent substitutions, improvements made within the spirit and principles of the present disclosure shall be included in the scope of the present disclosure.

What is claimed is:

1. A mobile work box, comprising:
a box body, comprising a plurality of storage portions and having an opening, wherein the plurality of storage portions are configured to store work tools therein, the plurality of storage portions are capable of being accessed through the opening;
a lid, detachably connected to the box body, wherein when the lid is connected to the box body, the lid covers the opening; and when the lid is detached off from the box body, the opening is exposed, and the plurality of storage portions are exposed through the opening; and
a plurality of casters, disposed at a bottom of the box body opposite to the opening, wherein the plurality of casters are movable.

2. The mobile work box according to claim 1, wherein the box body comprises two shorter side walls, two longer side walls, and a bottom wall;
the two shorter side walls and the two longer side walls are connected to the bottom wall;
the two shorter side walls, the two longer side walls, and the bottom wall cooperatively form the plurality of storage portions.

3. The mobile work box according to claim 2, wherein the plurality of storage portions comprises a bulk storage portion, a first side storage portion, and a second side storage portion; at least a portion of the bulk storage portion is disposed between the first side storage portion and the second side storage portion.

4. The mobile work box according to claim 3, wherein the first side storage portion comprises a first upper storage portion and a first lower storage portion; the second side storage portion comprises a second upper storage portion and a second lower storage portion.

5. The mobile work box according to claim 4, wherein the first lower storage portion comprises at least one first drawer that is slidable along a length direction of the box body; and the second lower storage portion comprises at least one second drawer that is slidable along a length direction of the box body;
the at least one first drawer is slidable in a first direction to be exposed out of the box body; the at least one second drawer is slidable in a second direction to be exposed out of the box body; the second direction is opposite to the first direction.

6. The mobile work box according to claim 5, wherein the box body further comprises a first side supporting plate and a first side dividing plate;
the first side supporting plate is disposed on a top of the at least one first drawer; three of four edges of the first side supporting plate are respectively connected to one of the two shorter side walls and the two longer side walls of the box body;
the first side dividing plate is connected to a rest one of the four edges of the first side supporting plate; the first side dividing plate is then extending from the rest one of the four edges of the first side supporting plate towards the opening of the box body;
the one of the two shorter side walls and portions of the two longer side walls of the box body, the first side supporting plate, and the first side dividing plate cooperatively form the first upper storage portion.

7. The mobile work box according to claim 6, wherein the bulk storage portion has a central storage space, a first side storage space, and a second side storage space;
the central storage space is located between the first side storage portion and the second side storage portion;
the first side storage space is defined between side walls of the at least one first drawer and the two longer side walls of the box body.

8. The mobile work box according to claim 6, wherein the first upper storage portion comprises two partition walls connected between the one of the two shorter side walls of the box body and the first side dividing plate; the two partition walls are extending from the first side supporting plate towards the opening;
the two partition walls, the one of the two shorter side walls of the box body, the first side dividing plate, and a portion of the first side supporting plate cooperatively define a first upper storage space to receive work tools.

9. The mobile work box according to claim 8, wherein the first side supporting plate has another portion extending away from the two partition walls and are disposed out of the first upper storage space; and the another portion defines through holes.

10. The mobile work box according to claim 7, wherein the box body further comprises a second side supporting plate and a second side dividing plate;
the second side supporting plate is disposed on a top of the at least one second drawer; three of four edges of the second side supporting plate are respectively connected to the other one of the two shorter side walls and the two longer side walls of the box body;
the second side dividing plate is connected to a rest one of the four edges of the second side supporting plate; the second side dividing plate is then extending from the rest one of the four edges of the second side supporting plate towards the opening of the box body;
the other one of the two shorter side walls and portions of the two longer side walls of the box body, the second side supporting plate, and the second side dividing plate cooperatively form the second upper storage portion.

11. The mobile work box according to claim 10, wherein the second side storage space is defined between side walls of the at least one second drawer and the two longer side walls of the box body.

12. The mobile work box according to claim 10, wherein the box body further comprises a movable storage tray that is disposed between the first upper side storage portion and the second upper side storage portion and occupies an upper portion of the bulk storage portion; the movable storage tray is movable between the two longer side walls of box body.

13. The mobile work box according to claim 12, wherein the box body further comprises a first tray supporting strip and a second tray supporting strip;
the first tray supporting strip is extending from a side of the first side dividing plate away from the first upper storage space towards the second upper storage portion; and
the second tray supporting strip is extending from a side of the second side dividing plate away from the second upper storage space towards the first upper storage portion;
two opposite sides of a bottom wall of the movable storage tray are respectively supported on and movable along the first tray supporting strip and the second tray supporting strip.

14. The mobile work box according to claim 13, wherein two opposite side walls of the movable storage tray are respectively limited by the first side dividing plate and the second side dividing plate.

15. The mobile work box according to claim 14, wherein the movable tray is detachable out of the bulk storage portion through the opening of the box body.

16. The mobile work box according to claim 12, wherein the movable storage tray comprises a plurality of removable dividers; when the plurality of removable dividers are removed out of the movable storage tray, the movable storage tray has a tray storage space; and when the plurality of removable dividers are arranged in the movable storage tray, the tray storage space is divided into a plurality of tray storage sub-spaces.

17. The mobile work box according to claim 1, wherein the box body is made of rigid materials; and the rigid materials comprise metal.

18. The mobile work box according to claim 1, wherein the plurality of casters are six casters.

19. The mobile work box according to claim 5, wherein the number of the at least one first drawer is two; and the number of the at least one second drawer is two.

20. The mobile work box according to claim 11, wherein the first upper storage portion and the second upper storage portion have a same length and a same width; a depth of the first upper storage portion is greater than a depth of the second upper storage portion.
